(19) United States
(12) Patent Application Publication
(10) Pub. No.: US 2005/0157668 A1
(43) Pub. Date: Jul. 21, 2005

(54) Wireless remote control and data transfer system

(76) Inventor: Michael Sivan, Hong Kong (HK)

Correspondence Address: Salans, 620 Fifth Avenue, New York, NY, 10020, US

(21) Appl. No.: 10/746,464

(22) Filed: Dec. 24, 2003

(51) Int. Cl. H04H 1/00

(52) U.S. Cl. 370/312; 340/825.72; 446/456; 455/41.2

(57) ABSTRACT

A wireless link system that allows multiple users to control and/or transfer data simultaneously from/to multiple wireless remote control units—to/from multiple wireless devices within a single radio frequency band. Such system consists of one or several remote units and one or several controlled devices. Each remote unit can be paired with a specific controlled device and control and/or transfer data to/from that specific controlled device without interfering with any other remote unit-controlled device pairs active at the same time, while all are the same frequency range.

### FIELD OF THE INVENTION

This invention relates to the field of wireless remote control and data transfer, and more particularly, to a wireless remote control and data transfer system and method for remotely controlling and remotely transferring of data from and to a plurality of devices simultaneously at the same radio frequency band and at the same radio environment.

### BACKGROUND OF THE INVENTION

The use of wireless means to link hardware units is known in the toy and gaming arts. Such wireless means primarily make use of transmission of radio frequency in specific frequency bands, or Infra-Red light. Such wireless means are typically used in two major toy applications—the transmission of data and the transmission of control commands. The following are examples of wireless remote controlled toys: remote control toy cars, airplanes, robots, toy-guns, etc. Examples of wireless data transfer systems for toys are walkie-talkies, talking dolls and talking stuffed animals (for audio data transfer), toy cameras (for photo transfer), and various toy electronic organizers and match-maker devices sending text messages each to the other.

While such wireless links exist, they are limited in that in order to keep the hardware costs low enough to be practical for use in connection with toys only a limited number of players can simultaneously play in the same radio environment at the same time, and the data transfer speed is relatively slow. Any attempted increase in the number of players or data speed requires more complex electronics resulting in higher hardware costs, making it virtually irrelevant for toy applications, which are extremely sensitive to hardware cost.

For example, De Angelis, in U.S. Pat. No. 5,885,159, discloses a system for and method of operating a plurality of remotely controlled vehicles simultaneously in a somewhat confined area. Specifically, De Angelis' system teaches the use of pads to remotely control the operation of selective vehicles, in which each pad has at least a first control for providing selection of the vehicle, second controls for providing the movement of the selected vehicle and third controls provide for the operation of working members in the selected vehicle. De Angelis' system differs significantly from the present invention in that it teaches the use of wireless transmission of control signals using random pattern with respect to time, the pseudo random pattern of the signals from each of the pads being different from the pseudo random pattern of the signals from the other pads, which by their nature require overall long slots of time and as such are inherently slow in transfer of commands, definitely too slow to transfer any meaningful data. The present invention provides for the wireless transmission of digital data at high speeds of 100-250 kbps.

Fainmesser, et al., U.S. Pat. No. 6,546,436, discloses a system which provides for a programmable toy interface for electrical connection with and control of a toy structure that is adapted to communicate with a computer and requiring computer resources. However, the use of a computer and its resources is impractical for low cost stand-alone toys.

Therefore, it can be appreciated that there exists a real need for a new wireless solution and system for wireless linking of toys that can allow a practically unlimited number of players to play simultaneously at the same radio frequency range, and provide for high speed data transfer, while keeping the overall embodiment simple and at low cost.

### BRIEF SUMMARY OF THE INVENTION

The present invention provides a multiple user wireless remote control and data transfer system for wireless linking of toys and other devices that can allow a practically unlimited number of players to play simultaneously at the same radio frequency range, and providing for high speed data transfer, while keeping the overall embodiment simple and at low cost.

There are a number of embodiments of the present invention including, but not limited to, one remote unit linking with one controlled device, multiple remote units linking with multiple controlled devices, acting in pairs, multiple remote units linking with a single controlled device, multiple interactions among multiple controlled devices and a single remote unit communicating with multiple remote units.

### BRIEF DESCRIPTION OF THE SEVERAL VIEWS OF THE DRAWINGS

FIG. 1 is a schematic block diagram showing the primary components of the present invention.

FIG. 2 is a block diagram of a preferred embodiment of the Wireless Controller IC.

FIG. 3 is a schematic diagram, primarily in block form, of a preferred embodiment of the present invention in which there are a plurality of remote units and a plurality of controlled devices.

FIG. 4 is a schematic diagram, primarily in block form, of an alternative embodiment of the present invention, namely a walkie-talkie toy system in which anyone can call anyone else.

FIG. 5 is a schematic diagram, primarily in block form, of an alternative embodiment of the present invention in which a dongle is attached to a computer and the controlled device is an Internet toy.

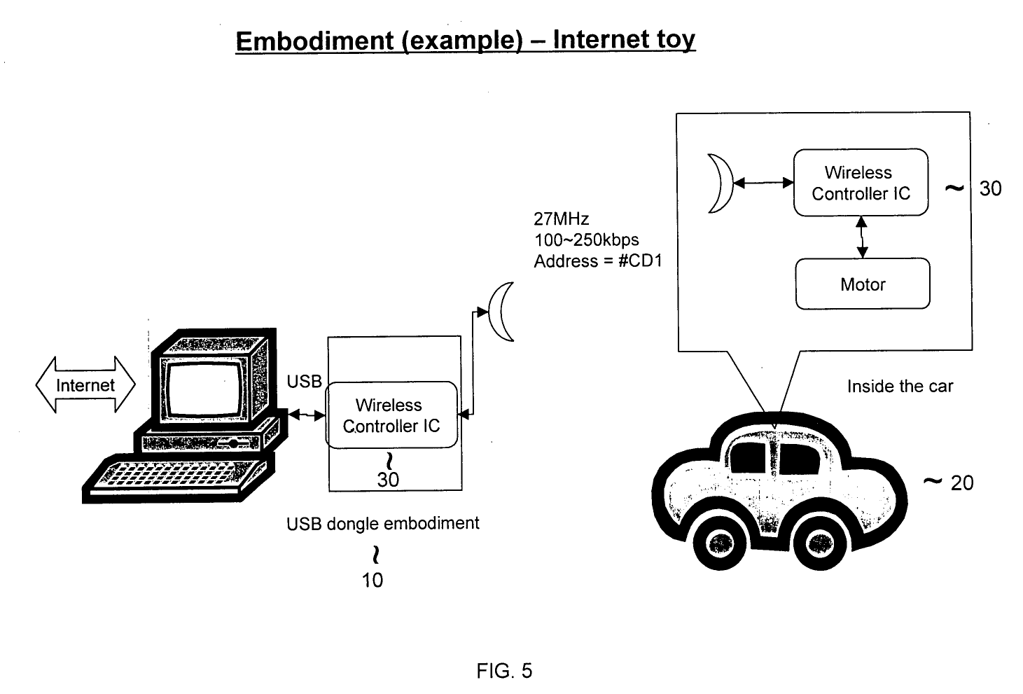

FIG. 6 is a block diagram showing one embodiment of the present invention in which the Wireless Controller IC is embedded in a remote unit which is a remote controller for remote controlled vehicles.

FIG. 7 is a block diagram showing one embodiment of the present invention in which the Wireless Controller IC is embedded in a controlled device which is a remote controlled

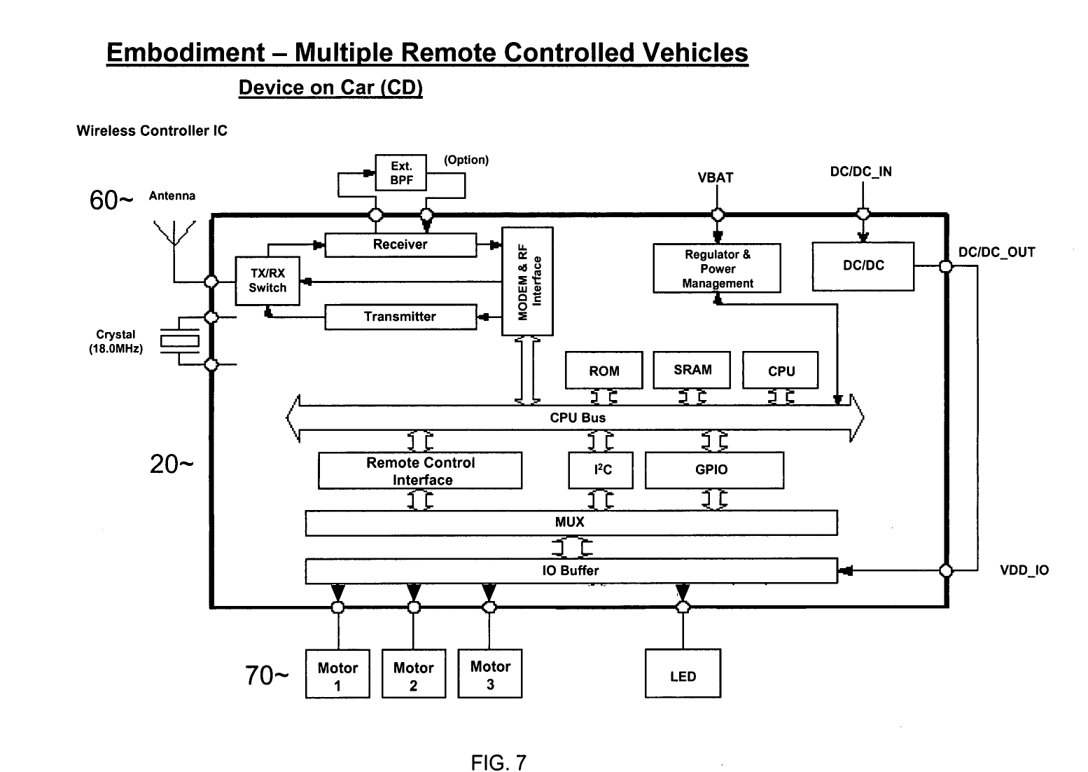

FIG. 8 is a block diagram showing an embodiment of the present invention in which the Wireless Controller IC is embedded in a walkie-talkie.

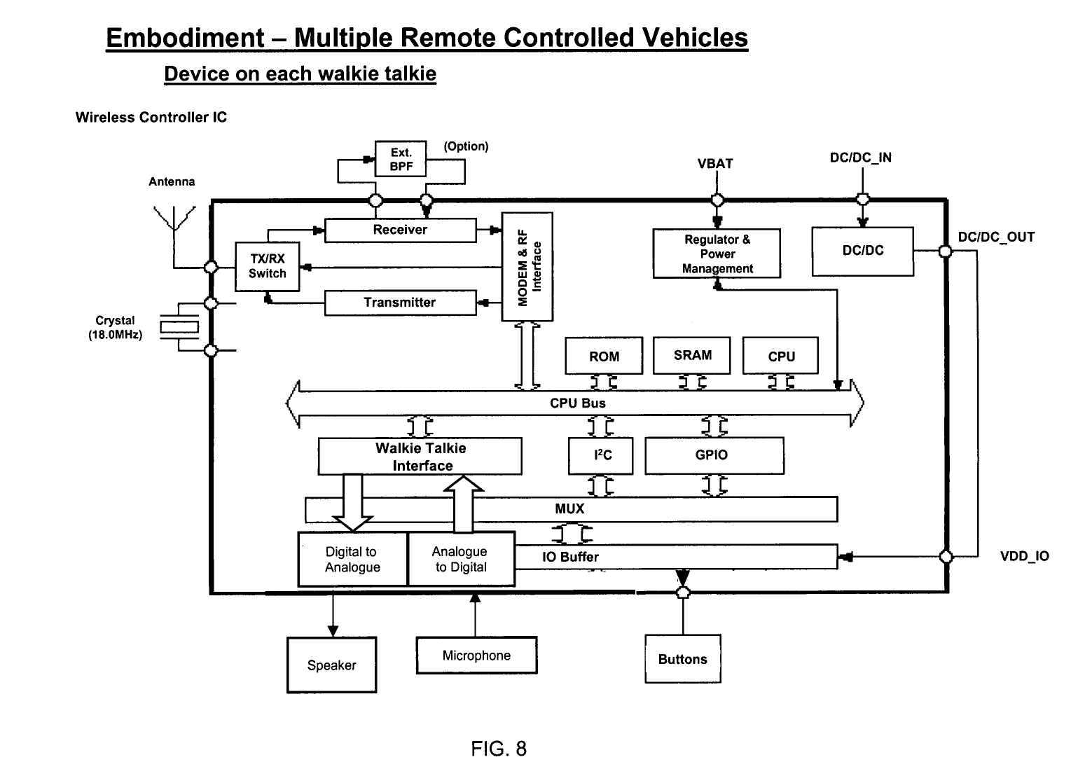

### DETAILED DESCRIPTION OF THE INVENTION

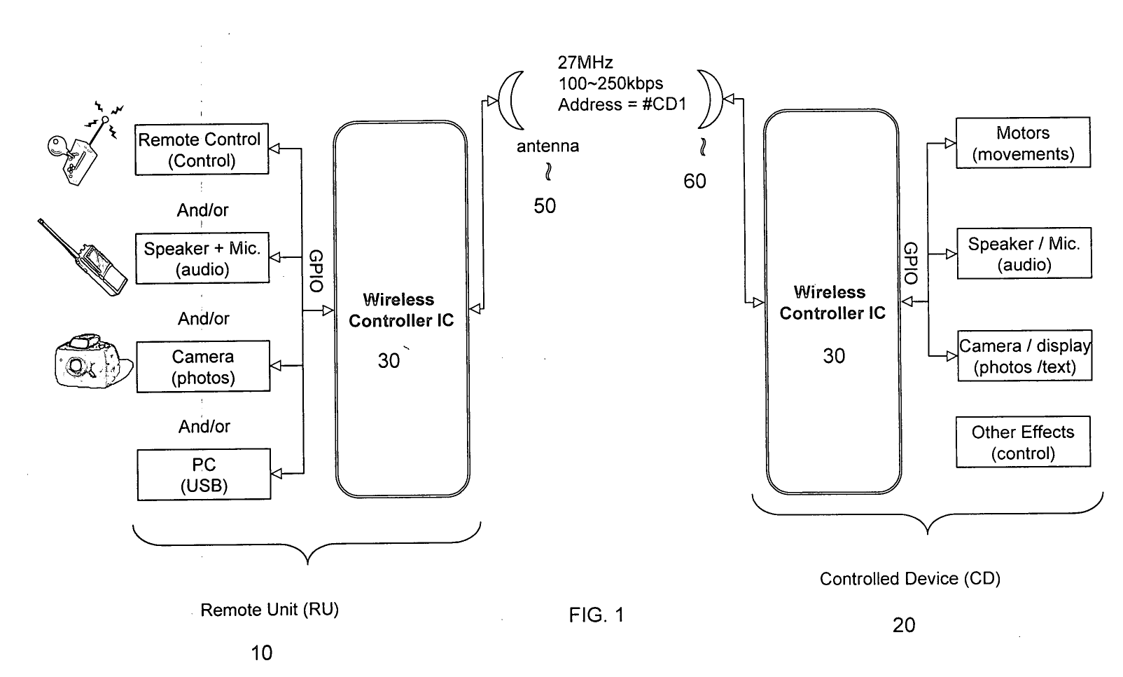

Referring to FIG. 1, the system consists of at least one remote unit 10 and at least one controlled device 20. Each of the remote units 10 and controlled devices 20 have in their core a Wireless Controller IC 30. Each of the remote units 10 contains an antenna 50. Each of the controlled devices 20 also contains an antenna 60. There are various possible embodiments of the remote unit including, but not limited to: remote controller, walkie-talkie, and toy gun. Examples of embodiments of the controlled device 20 include, but are not limited to: toy car, toy robot (whether humanoid or else), toy airplane, camera, walkie-talkie, toy gun, headset, speaker, display unit, baby monitor, wireless security sensor and wireless web camera.

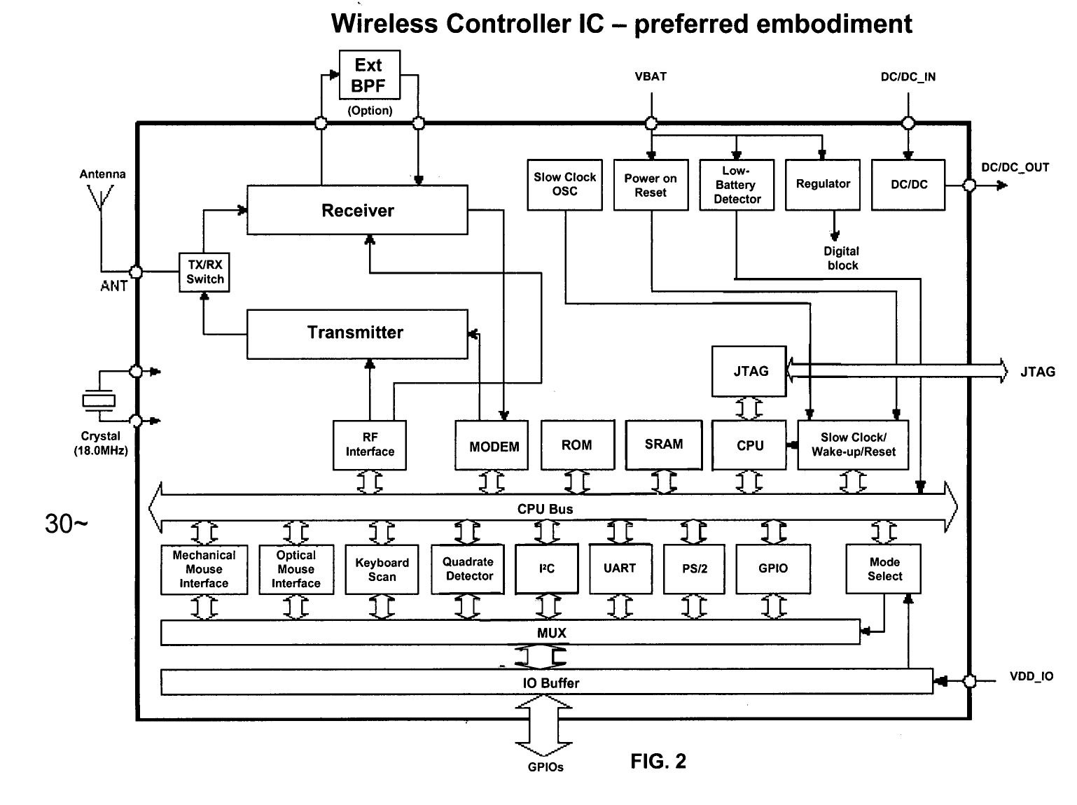

This invention makes use of a Wireless Controller IC 30, and in the preferred embodiment, a JAALAA JA3204, which is commercially available and manufactured by JAALAA, Inc. FIG. 2 is an example of a preferred embodiment of the Wireless Controller IC 30. The Wireless Controller IC 30 enables low cost embodiments that are a critical requirement for toys, thereby providing a new dimension in smart low cost electronic toys. Wireless Controller IC's, other than the JAALAA JA3204, may also be used in connection with the present invention.

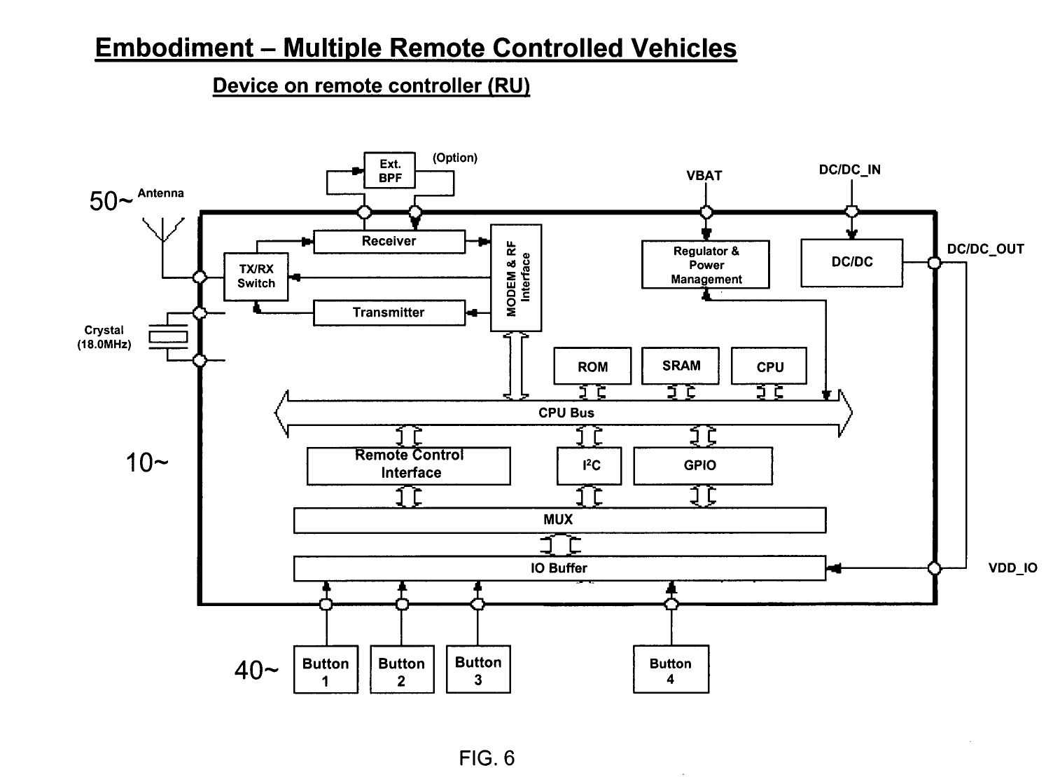

As illustrated in FIG. 6, in one embodiment of the present invention, in which at least one remote unit 10 is used to remotely control at least one controlled device 20 which is a toy vehicle, one or more buttons 40 on the remote unit 10 are pressed and the remote unit 10 transmits multiple digital data signals to a controlled device 20, in bursts at speeds of 100-250 kbps. The digital data is generic and is programmed specifically for every embodiment to transfer control commands and/or data of the required type. Such data can be control commands, or other digital data. Such digital data can be audio data (including, but not limited to, MP3, WMA, WAV, and MID), photo data (including, but not limited to, JPEG, BMP, TIFF, etc.), data files (including, but not limited to, TXT, DOC, XLS, etc.).

The multiple wireless transmissions are all in a single frequency band, still not requiring complex RF filters. This is because in this embodiment the Wireless Controller IC 30 incorporates a proprietary media access control (MAC) protocol that provides highly reliable data transfer to remote devices in an environment with multiple other wireless users.

Each data transmission burst from a remote unit 10 is programmed to include the address of that controlled device 20 to which the data is intended to reach. Each controlled device 20 is programmed to receive and act only upon commands and data addressed to it, while ignoring data transmitted to other addressees, such process is handled within the proprietary MAC protocol of the Wireless Controller IC 30, such Wireless Controller IC 30 is embedded in each of the remote units 10 and the controlled devices 20.

The controlled device 20 receives the transmission, decodes it under the MAC protocol and after the controlled device 20 determines that the transmission was addressed to it, directly drives the motor(s) 70 in sequence as per the original commands provided from the remote unit 10.

The preferred embodiment of this invention is for the single frequency band of 27 MHz, which does not require a license to be used and is already in use for wireless remote control toys as well as walkie-talkies, and more. However, other frequency bands (such as 49 MHz, 400 MHz, 900 MHz, 2.4 GHz, 5 GHz, etc.) are within the scope of this invention as well.

This invention further provides for similar transfer of digital data not only between remote unit 10 and controlled device 20, but among controlled devices 20, one with the other, in any combination and all at the same time, all still in the same single radio frequency band.

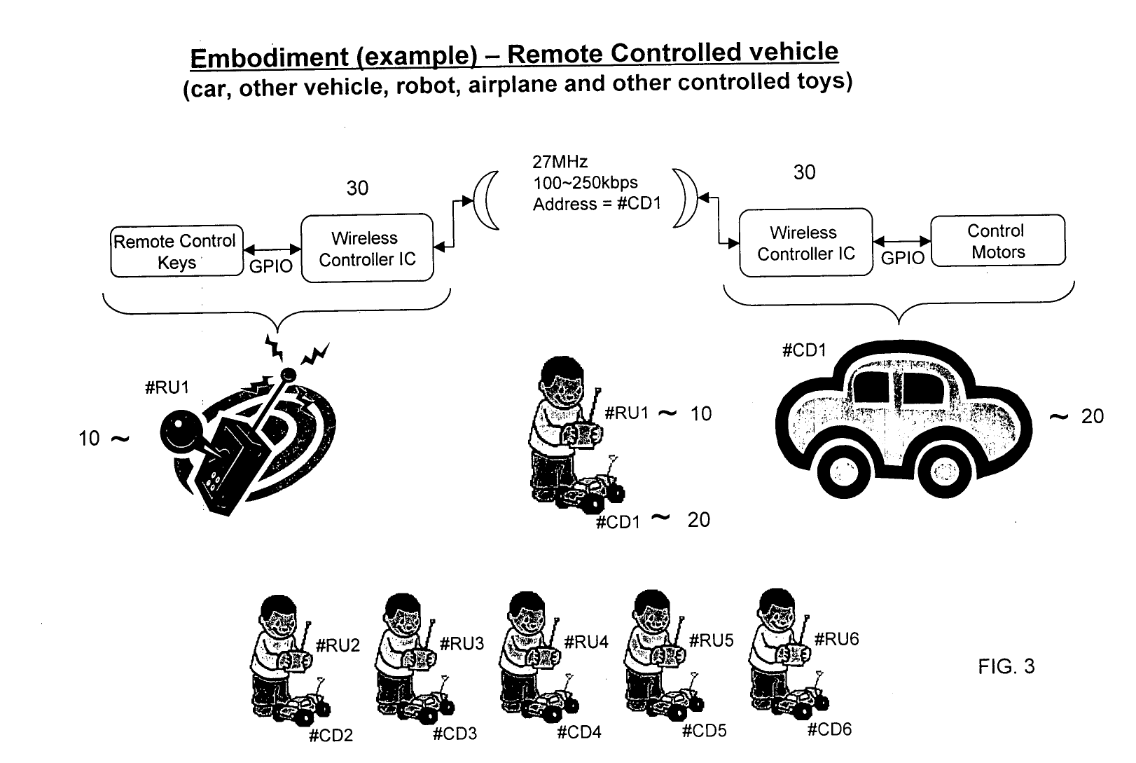

The preferred embodiment of the present invention is multiple remote units 10 in the same radio environment, in which each remote unit 10 simultaneously transmits and receives control commands and data to multiple corresponding controlled devices 20, as shown in FIG. 3. An example of such embodiment is a scenario in which there are 5 players each controlling a basketball robot-player (with a hand-held remote controllers), fighting against 5 other players with similar robots, all in a toy set that consists of 10 robots and 10 remote units, each with a Wireless Controller IC 30 in it.

An alternative embodiment of the present invention is a single remote unit 10 linking with a single controlled device 20 for transfer of control commands and data. One possible use of this embodiment is a remote controller activating a toy car, as shown in FIG. 3 wherein remote unit 10 transmits data to controlled device 20.

Another possible embodiment of the present invention is a single remote unit 10 embodied as a USB dongle connecting to a computer and wirelessly transferring MP3 music to a controlled device 20 embodied as a wireless stereo headset with MP3 decoder. A USB dongle is a hardware device that connects to the USB port of a computing device such as, for example, a personal computer, notebook or PDA device.

Multiple remote units 10 can be programmed to address the same controlled device 20 as another embodiment of the present invention. Such embodiment allows two or more players to control simultaneously and in parallel the same toy. This provides for a new style of toys that provide for cooperative gaming between two players on the same toy or game, without the need to duplicate two or more receivers on the same controlled device 20, and without the need to worry of interference between receivers.

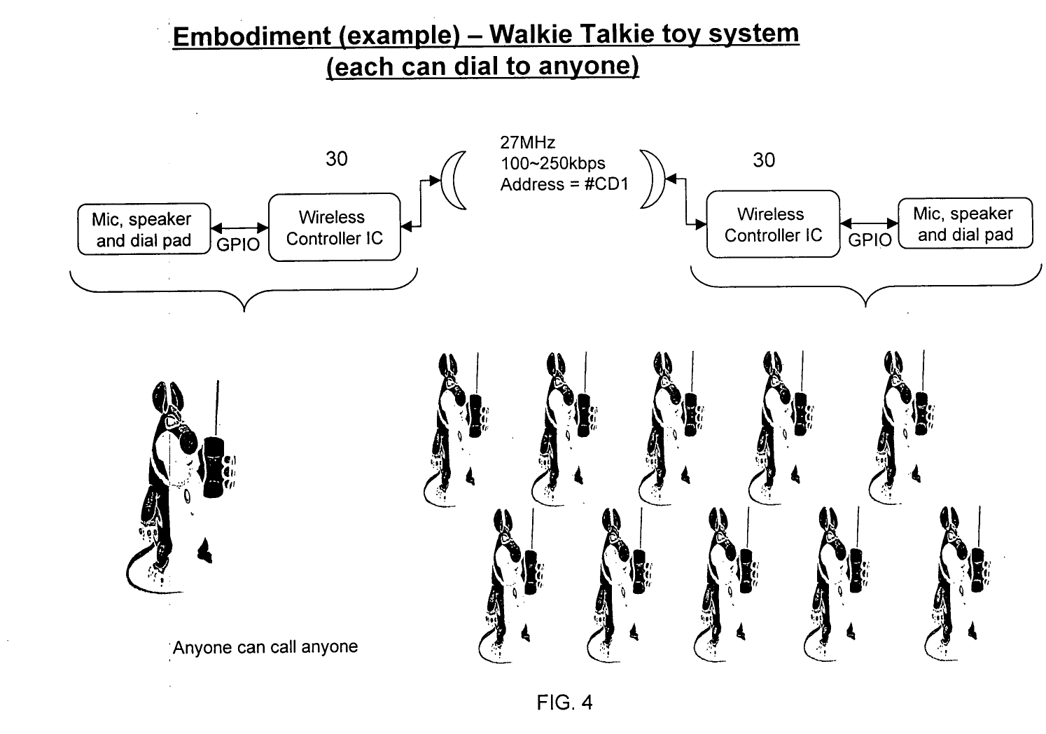

Multiple interactions among controlled devices 20 themselves is a further embodiment of the present invention. An example of this embodiment, as shown in FIG. 4, is multiple walkie-talkies operating in a network in which each walkie-talkie can ‘dial’ to any other specific walkie-talkie and talk only to that one. Such network of walkie-talkies, each equipped with a low-cost CMOS sensor, allows each unit to take photos and send such photos to any specific walkie-talkie in that network (in addition to the voice communications).

Another alternative embodiment of the present invention is a single remote unit 10 that communicates with multiple controlled units 20. An example of this embodiment is same multiple walkie-talkie networks in which one user addresses all other users simultaneously (i.e. broadcasting). A further illustration of this embodiment is a remote unit 10 embodied as a USB dongle that connects to the USB port of a computer, sending MP3 encoded hi-fi music to 5 controlled units 20, each decoding the MP3 back to audio and each embodied as an audio dongle connecting to a specific hi-fi speaker, such system allowing full wireless surround speakers hi-fi system.

A further alternative embodiment of the present invention is at least one remote unit 10 having the ability to change on demand from communicating with one controlled device 20 to communicating with a different controlled device, by dynamically changing the address of the controlled device to which the digital data is intended to reach. For example, in an embodiment in which there are three remote units 10, namely, RU1, RU2 and RU3, transferring control and data to three controlled devices 20, namely, CD1, CD2 and CD3, in pairs respectively, after such dynamic programming, RU1, RU2 and RU3, will transfer control and data to CD2, CD3 and CD1, in pairs respectively. Other combinations are also possible. In another embodiment, the controlled devices of a system comprised of a plurality of controlled devices have the ability to dynamically change communications to different specific controlled devices. In a multiple walkie-talkie system, the user may select to whom they want to talk by ‘dialing’ the number of that walkie-talkie, thereby setting a new address for the Wireless Controller IC to whom the audio data will be transferred.

In addition to toys, the present invention may be used in connection with, for example, a low cost security system.

It will be clear that the present invention is well adapted to carry out the objects and attain the ends and advantages mentioned as well as those inherent therein. While presently preferred embodiments have been described for purposes of this disclosure, numerous changes may be made which will readily suggest themselves to those skilled in the art and which are encompassed in the spirit of the invention disclosed and as defined in the appended claims.

1. A multiple user wireless remote control and data transfer system comprising:
at least one wireless remote unit, each having a Wireless Controller IC;
at least one wireless controlled device, each having a Wireless Controller IC; and
said wireless remote units simultaneously transmit and receive digital data to and from said wireless controlled devices at the same radio frequency band using a specific media access control protocol tailored for each specific application.

2. The system of claim 1 further comprising a predetermined identifying component transmitted by said wireless remote unit to a predetermined wireless controlled device.

3. The system of claim 1 further comprising a predetermined identifying component, said wireless controlled device only accepts signals including the predetermined identifying component.

4. The system of claim 1 further comprising said wireless controlled devices having the ability to verify that the transmission was addressed to said wireless controlled device.

5. The system of claim 1 further comprising said wireless controlled device capable of transmitting a confirmation transmission to said corresponding wireless remote unit.

6. The system of claim 1 further comprising a second or more wireless remote units, said plurality of wireless remote units simultaneously transmit and receive signals to and from said wireless controlled device.

7. The system of claim 1 further comprising a second or more wireless controlled devices, said wireless remote unit transmits and receives digital data simultaneously to and from said plurality of wireless controlled devices.

8. The system of claim 1 further comprising a second or more wireless remote units and a second wireless controlled device, each said wireless remote unit simultaneously transmits and receives signals to and from a predetermined wireless controlled device.

9. The system of claim 1 further comprising transmission speeds ranging from 100 to 250 kbps.

10. The system of claim 1 further comprising said radio frequency of about 27 MHz.

11. The system of claim 1 further comprising said radio frequency selected from the group consisting of: about 49 MHz, about 400 MHz, about 900 MHz, about 2.4 GHz and about 5 GHz.

12. The system of claim 1 further comprising the transfer of audio digital data.

13. The system of claim 12 further comprising said audio digital data of a file type selected from the group consisting of: MP3, WMA, WAV and MID.

14. The system of claim 1 further comprising the transfer of photo digital data.

15. The system of claim 14 further comprising said photo digital data of a file type selected from the group consisting of: JPEG, BMP and TIFF.

16. The system of claim 1 further comprising said digital data consisting of data files.

17. The system of claim 16 further comprising said data files of a file type selected from the group consisting of: TXT, DOC and XLS.

18. The system of claim 1 further comprising a wireless remote unit which is a remote controller for a toy.

19. The system of claim 1 further comprising a wireless controlled device which is a remote controlled toy.

20. The system of claim 1 further comprising said wireless remote unit embedded in a dongle which is connected to a computing device through a standard port, said wireless remote unit transmits and receives digital data to and from said one or more wireless controlled devices by command of a software program on the computing device or a user interface of the computing device.

21. The system of claim 1 further comprising said wireless remote unit embedded in a dongle which is connected to a computing device through a standard port, said wireless remote unit transmits and receives digital data to and from said one or more wireless controlled devices by command of a software program from any remote personal computer through the internet connecting to the computing device.

22. The system of claim 21 wherein the wireless controlled devices are baby monitors.

23. The system of claim 21 wherein the wireless controlled devices are toy vehicles or toy robots.

24. The system of claim 21 wherein the wireless controlled devices are wireless security sensors.

25. The system of claim 21 wherein the wireless controlled devices are wireless web cameras.

26. The system of claim 1 further providing for the ability to dynamically change the program inside the wireless remote units and the wireless controlled devices relating to addressing in such a way that different wireless remote units will transmit and receive control and data to and from a new set of specific wireless controlled devices.

27. A multiple user wireless remote control and data transfer system comprising:
a plurality of wireless controlled devices, each having a Wireless Controller IC; and
said wireless controlled devices simultaneously transmit and receive digital data to and from said wireless controlled devices at the same radio frequency band using specific media access control protocol tailored for each specific application.

28. The system of claim 27 further comprising a predetermined identifying component transmitted by said wireless controlled device to a predetermined wireless controlled device.

29. The system of claim 27 further comprising a predetermined identifying component, said wireless controlled device only accepts signals including the predetermined identifying component.

30. The system of claim 27 further comprising said wireless controlled devices having the ability to verify that the transmission was addressed to said wireless controlled device.

31. The system of claim 27 further providing for the ability to dynamically change the program inside the wireless controlled devices relating to addressing in such a way that different wireless controlled devices will transmit and receive control and data to and from a new set of specific wireless controlled devices.

32. The system of claim 27 wherein the wireless controlled device is a walkie-talkie.

33. A multiple user wireless remote control and data transfer system comprising:
a plurality of wireless remote units, each having a Wireless Controller IC; and
one of said wireless remote units simultaneously transmits and receives digital data to and from said plurality of wireless remote units at the same radio frequency band using specific media access control protocol tailored for each specific application.

34. The system of claim 33 further comprising a predetermined identifying component transmitted by said wireless remote unit to a predetermined wireless remote unit.

35. The system of claim 33 further comprising a predetermined identifying component, said wireless remote unit only accepts signals including the predetermined identifying component.

36. The system of claim 33 further comprising said wireless remote unit having the ability to verify that the transmission was addressed to said wireless remote unit.

37. A multiple user wireless remote control and data transfer system wherein the system is a toy system using the wireless systems of any of claims 1, 27 or 33.

38. A method of using a multiple user wireless remote control and data transfer system in a low cost environment comprising the steps of:
installing a Wireless Controller IC in a wireless remote unit; and
installing a Wireless Controller IC in a wireless controlled device in a manner effective to receive digital data from the wireless remote unit.

39. The method of claim 38 further comprising a Wireless Controller IC which is a JAALAA JA3204.
